(19) United States
(12) Patent Application Publication
(10) Pub. No.: US 2011/0035392 A1
(43) Pub. Date: Feb. 10, 2011

(54) AUTOMATED ACTIVE KEYWORD CONTENT SEARCHING

(75) Inventor: Nixon Cheaz, Cary, NC (US)

Correspondence Address: LEE LAW, PLLC;IBM CUSTOMER NUMBER, P.O. BOX 189, PITTSBORO, NC, 27312, US

(73) Assignee: International Business Machines Corporation, Armonk, NY (US)

(21) Appl. No.: 12/538,252

(22) Filed: Aug. 10, 2009

(51) Int. Cl. G06F 17/30

(52) U.S. Cl. 707/758; 707/E17.014

(57) ABSTRACT

A keyword for use in automated searches of items of content subsequently received is configured at a content processing device. An item of content is received at the content processing device. A search within the item of content for the keyword is automatically performed. An alert is generated upon identification of the keyword within the item of content.

### BACKGROUND

The present invention relates to text searching within content received by a device. More particularly, the present invention relates to automated active keyword content searching.

Users of web browsers may navigate to various web pages by entering uniform resource locators (URLs) or by selecting hypertext links within rendered web content. Upon entry of a URL or selection of a hypertext link, a web page associated with the URL or hypertext link is retrieved from a server that stores the associated content. The content may include text content and images, and may also include executable scripts. When received by the web browser, the content is processed and displayed on a display device.

### SUMMARY

A method includes configuring, at a content processing device, a keyword for use in automated searches of items of content subsequently received at the content processing device; receiving an item of content at the content processing device; automatically performing a search within the item of content for the keyword; and generating an alert upon identification of the keyword within the item of content.

A system includes a content processing device programmed to: configure a keyword for use in automated searches of items of content subsequently received; receive an item of content; automatically perform a search within the item of content for the keyword; and; and generate an alert upon identification of the keyword within the item of content.

A computer program product includes a computer useable storage medium including a computer readable program code, wherein the computer readable program code when executed on a computer causes the computer to: configure a keyword for use in automated searches of items of content subsequently received; receive an item of content; automatically perform a search within the item of content for the keyword; and generate an alert upon identification of the keyword within the item of content.

### BRIEF DESCRIPTION OF THE SEVERAL VIEWS OF THE DRAWINGS

FIG. 1 is a block diagram of an example of an implementation of a system for automated active keyword content searching according to an embodiment of the present subject matter;

FIG. 2 is a block diagram of an example of an implementation of a content processing device that is capable of performing automated active keyword content searching based upon configured active keywords according to an embodiment of the present subject matter;

FIG. 3 is a flow chart of an example of an implementation of a process for automated active keyword content searching according to an embodiment of the present subject matter; and

FIG. 4 is a flow chart of an example of an implementation of a process for automated active keyword content searching based upon character patterns, and search result selection, according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides automated active keyword content searching for content processing devices. An active keyword is configured for automated searching of content subsequently received at a content processing device and includes single and multiple word phrases. Active keywords also include single and multiple element character patterns. Multiple active keywords may be configured and each item of content subsequently received may be searched for each configured active keyword. As such, either a single keyword or multiple keywords may be included within a single keyword search pattern and one or more patterns (e.g., sets of keywords) may be searched for each item of content that is received.

Content processing devices include devices such as devices that include web browsers, email, text, and instant message (IM) processing capabilities, as well as other devices that receive and process content. Further, stream feed reader content and file opening activities may also be processed in accordance with the present subject matter to provide automated active keyword content searching for such content processing devices. Content processing devices may also include intermediate devices, such as local and/or proxy servers.

Upon receipt of each item of content at the content processing device, a search is automatically performed within the received content for any configured keyword(s). An alert is generated upon identification of any configured keyword(s) within the received content. An active keyword may include single or multiple keywords, or character patterns, that may further include a wildcard and/or an exclusionary term. Pattern matching may further be performed using any configured wildcard(s) or exclusionary term(s). Close matches of configured keywords within received content may also be identified.

A wildcard may be configured in the form of an asterisk (e.g., “*”), an exclamation point (e.g., “!”), or any other suitable character or character combination. A wildcard may be concatenated to a portion of a word (e.g., “search*” to denote that the terms “search,” “searching,” and “searches” should be returned). Pattern matching may be performed in combination with the use of wildcards, for example, to configure searches for “unassisted double plays” and “unassisted triple plays” (e.g., “unassisted*play where*==double or triple”). Wildcards and exclusionary terms may be combined to form compound active keywords for searches. An exclusionary term may include any term or character combination that is to be excluded from any search results. For example, if a user is interested in baseball and in identifying unassisted double or triple plays on web sites that the user reviews on a daily basis, but is not interested in results associated with a certain team (e.g., “Base Takers”), the team name may be configured as an exclusionary term so that no results that include that team name are returned from a search (e.g., ““unassisted*play where*==double or triple and not Base Takers”). Many other configurations and combinations of active keywords are possible and all are considered within the scope of the present subject matter.

Additionally, it should be noted that the present subject matter also applies to multi-page content. Multi-page content may include lists of items or other content that is either received or rendered sequentially. As such, when content is initially received, the first rendered page will be searched for active keywords. Upon navigation to and rendering of additional pages, each subsequent page of content will be searched for active keywords automatically. In this way, each page of content is automatically searched for configured search criteria without requiring the user to re-enter search criteria for each page of content rendered.

The automated active keyword content searching described herein may be performed in real time to allow prompt searching for configured search criteria upon receipt of content at a content processing device. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

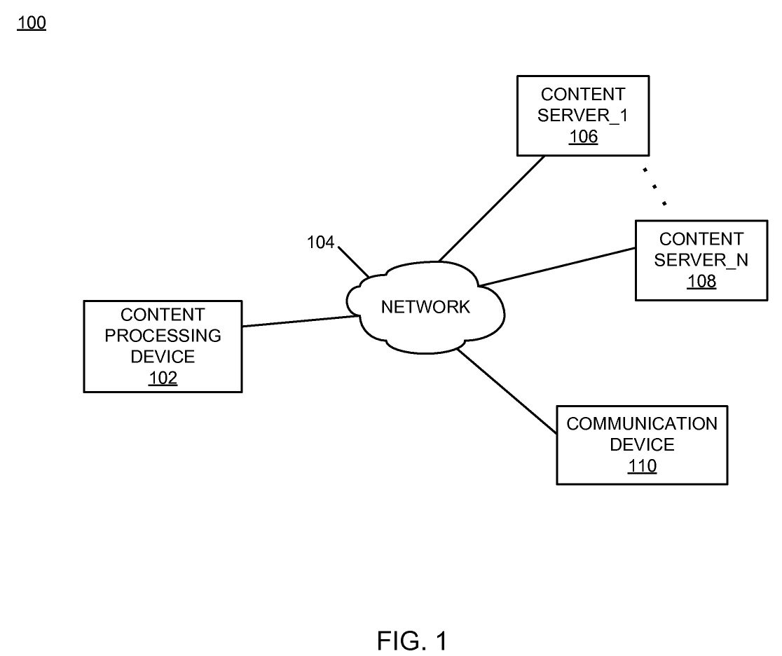

FIG. 1 is a block diagram of an example of an implementation of a system 100 for automated active keyword content searching. Within the system 100, a content processing device 102 communicates via a network 104 with a content server_1 106 through a content server_N 108, and with a communication device 110.

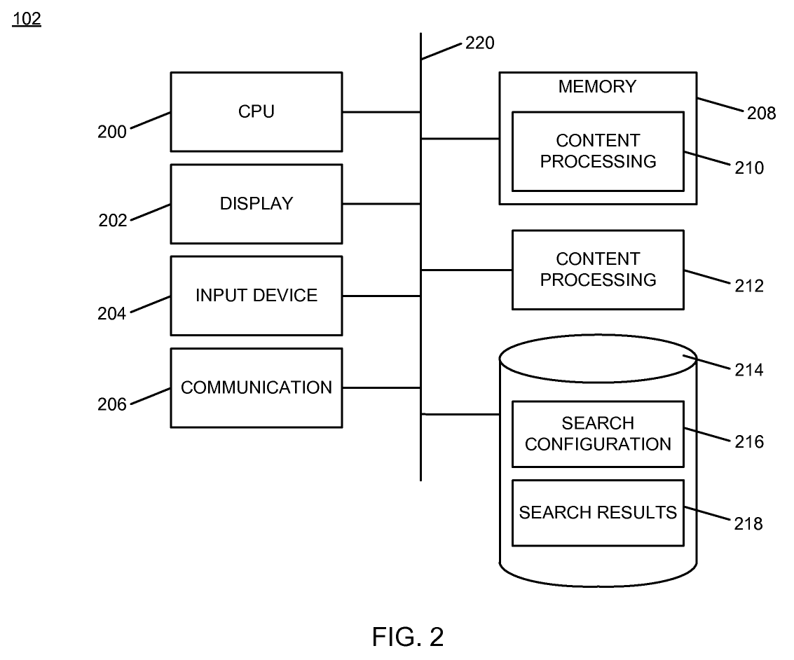

As will be described in more detail below in association with FIG. 2 through FIG. 4, the content processing device 102 provides automated active keyword searching for content received from any of the content server_1 106 through the content server_N 108, or from the communication device 110. A user of the content processing device 102 may configure active keywords for prospective automated content receipt searches (e.g., subsequently received) in advance of receipt of any content from any such device. Upon navigation to a web page accessible via one of the content server_1 106 through the content server_N 108, the content processing device 102 performs an automated active keyword search within the received web content prior to or in conjunction with rendering the web content. Similarly, upon receipt of an email, a text message, or instant message (IM) from a device, such as the communication device 110, the content processing device 102 performs an automated active keyword search within the received email, text message, or instant message.

For example, a user of the content processing device 102 may be responsible for maintenance or technical support activities associated with a deployed system (not shown). The user may configure, via the content processing device 102, certain active keywords to cause the content processing device 102 to generate an alert upon receipt of an email, text message, or instant message associated with a problem with the deployed system. In such a situation the user may configure, via the content processing device 102, one or more active keywords, such as “application server” and/or “application developer.” Subsequently, upon receipt of an email, a text message, or an instant message, the content of any such communication is automatically searched for the configured active keyword(s) and an alert is generated upon identification of any configured active keyword(s) to allow the user to process the content and respond more quickly to any issue represented within the received content.

It should be noted that the content processing device 102 may be a portable computing device, either by a user's ability to move the content processing device 102 to different locations, or by the content processing device 102's association with a portable platform, such as a plane, train, automobile, or other moving vehicle. It should also be noted that the content processing device 102 may be any computing device capable of processing information as described above and in more detail below. For example, the content processing device 102 may include devices such as a personal computer (e.g., desktop, laptop, palm, etc.) or a handheld device (e.g., cellular telephone, personal digital assistant (PDA), email device, music recording or playback device, etc.), or any other device capable of processing information as described in more detail below.

The content server_1 106 through the content server_N 108 provide web content that may be accessed by the content processing device 102. As such, the content server_1 106 through the content server_N 108 represent web servers and other content servers for purposes of the present description.

The network 104 may include any form of interconnection suitable for the intended purpose, including a private or public network such as an intranet or the Internet, respectively, direct inter-module interconnection, dial-up, wireless, or any other interconnection mechanism capable of interconnecting the respective devices.

FIG. 2 is a block diagram of an example of an implementation of the content processing device 102 that is capable of performing automated active keyword content searching based upon configured active keywords. A central processing unit (CPU) 200 provides computer instruction execution, computation, and other capabilities within the content processing device 102. A display 202 provides visual information to a user of the content processing device 102 and an input device 204 provides input capabilities for the user.

The display 202 may include any display device, such as a cathode ray tube (CRT), liquid crystal display (LCD), light emitting diode (LED), projection, touchscreen, or other display element or panel. The input device 204 may include a computer keyboard, a keypad, a mouse, a pen, a joystick, or any other type of input device by which the user may interact with and respond to information on the display 202.

A communication module 206 provides interconnection capabilities that allow the content processing device 102 to communicate with other modules within the system 100, such as the content server_1 106 through the content server_N 108, to retrieve web content, or the communication device 110 to receive email, text, or IM content. The communication module 206 may include any electrical, protocol, and protocol conversion capabilities useable to provide the interconnection capabilities. Though the communication module 206 is illustrated as a component-level module for ease of illustration and description purposes, it should be noted that the communication module 206 may include any hardware, programmed processor(s), and memory used to carry out the functions of the communication module 206 as described above and in more detail below. For example, the communication module 206 may include additional controller circuitry in the form of application specific integrated circuits (ASICs), processors, antennas, and/or discrete integrated circuits and components for performing communication and electrical control activities associated with the communication module 206. Additionally, the communication module 206 may include interrupt-level, stack-level, and application-level modules as appropriate. Furthermore, the communication module 206 may include any memory components used for storage, execution, and data processing for performing processing activities associated with the communication module 206. The communication module 206 may also form a portion of other circuitry described without departure from the scope of the present subject matter.

A memory 208 includes a content processing storage area 210 that stores information and content that is received by the content processing device 102. The content processing storage area 210 may also store any variables used for processing content received by the content processing device 102 and provides a location for storage, parsing, and processing of the received content associated with the automated active keyword content searching.

It is understood that the memory 208 may include any combination of volatile and non-volatile memory suitable for the intended purpose, distributed or localized as appropriate, and may include other memory segments not illustrated within the present example for ease of illustration purposes. For example, the memory 208 may include a code storage area, a code execution area, and a data area without departure from the scope of the present subject matter.

The content processing device 102 also includes a content processing module 212. The content processing module 212 implements the automated active keyword content searching for the content processing device 102. The content processing module 212 provides search capabilities for the content processing device 102 based upon configured keywords, character patterns, wildcards, and exclusionary terms, along with any other suitable search criteria.

Though the content processing module 212 is illustrated as a component-level module for ease of illustration and description purposes, it should be noted that the content processing module 212 may include any hardware, programmed processor(s), and memory used to carry out the functions of this module as described above and in more detail below. For example, the content processing module 212 may include additional controller circuitry in the form of application specific integrated circuits (ASICs), processors, and/or discrete integrated circuits and components for performing communication and electrical control activities associated with the content processing module 212. Additionally, the content processing module 212 may also include interrupt-level, stack-level, and application-level modules as appropriate. Furthermore, the content processing module 212 may include any memory components used for storage, execution, and data processing for performing processing activities associated with the content processing module 212.

It should also be noted that the content processing module 212 may form a portion of other circuitry described without departure from the scope of the present subject matter. Further, the content processing module 212 may alternatively be implemented as an application stored within the memory 208. In such an implementation, the content processing module 212 may include instructions executed by the CPU 200 for performing the functionality described herein. The CPU 200 may execute these instructions to provide the processing capabilities described above and in more detail below for the content processing device 102. The content processing module 212 may form a portion of an interrupt service routine (ISR), a portion of an operating system, a portion of a browser application, or a portion of a separate application without departure from the scope of the present subject matter.

A database 214 is associated with the content processing device 102 and provides storage capabilities for information associated with the automated active keyword content searching of the content processing device 102. The database 214 includes a search configuration storage area 216 and a search results storage area 218 that may be stored in the form of tables or other arrangements accessible by the content processing device 102. The search configuration storage area 216 includes information associated with active keywords, such as character patterns, wildcards, and exclusionary terms. The search results storage area 218 includes results of active searches performed on content received by the content processing device 102.

The CPU 200, the display 202, the input device 204, the communication module 206, the memory 208, and the database 214 are interconnected via an interconnection 220. The interconnection 220 may include a system bus, a network, or any other interconnection capable of providing the respective components with suitable interconnection for the respective purpose.

While the content processing device 102 is illustrated with and has certain components described, other modules and components may be associated with the content processing device 102 without departure from the scope of the present subject matter. Additionally, it should be noted that, while the content processing device 102 is described as a single device for ease of illustration purposes, the components within the content processing device 102 may be co-located or distributed and interconnected via a network without departure from the scope of the present subject matter. For a distributed arrangement, the display 202 and the input device 204 may be located at a point of sale device, kiosk, or other location, while the CPU 200 and memory 208 may be located at a local or remote server. Many other possible arrangements for components of the content processing device 102 are possible and all are considered within the scope of the present subject matter. It should also be understood that, though the search configuration storage area 216 and the search results storage area 218 are shown within the database 214, they may also be stored within the memory 208 without departure from the scope of the present subject matter. Accordingly, the content processing device 102 may take many forms and may be associated with many platforms.

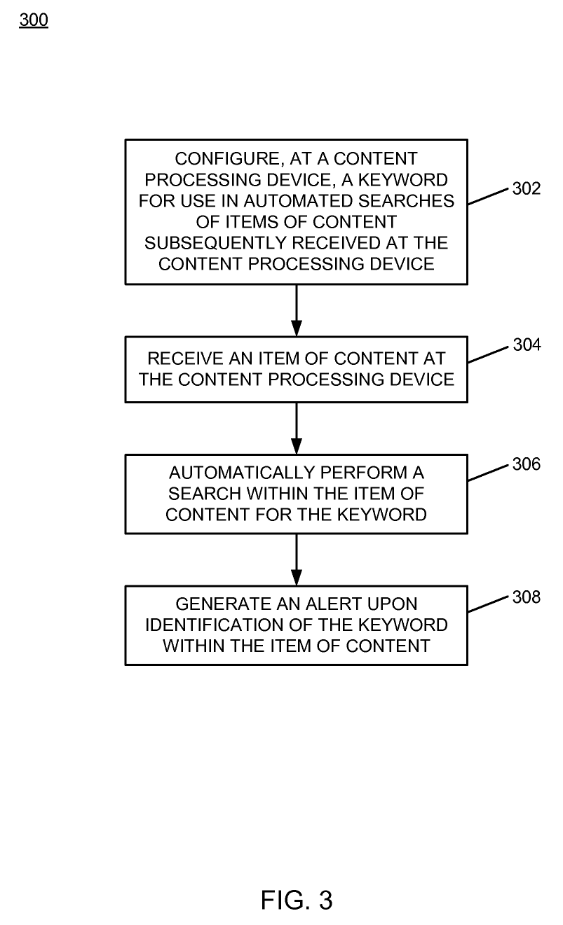

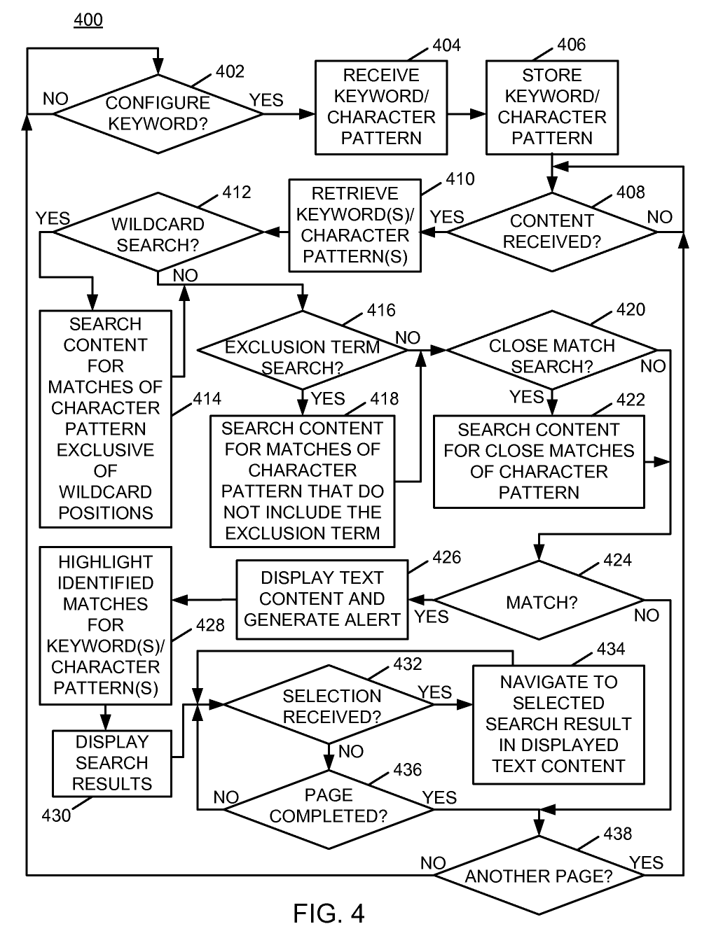

FIG. 3 and FIG. 4 below describe example processes that may be executed by devices, such as the content processing device 102, to perform the automated active keyword content searching associated with the present subject matter. Many other variations on the example processes are possible and all are considered within the scope of the present subject matter. The example processes may be performed by modules, such as the content processing module 212 and/or executed by the CPU 200, associated with such devices. It should be noted that time out procedures and other error control procedures are not illustrated within the example processes described below for ease of illustration purposes. However, it is understood that all such procedures are considered to be within the scope of the present subject matter.

FIG. 3 is a flow chart of an example of an implementation of a process 300 for automated active keyword content searching. At block 302, the process 300 configures, at a content processing device, a keyword for use in automated searches of items of content subsequently received at the content processing device. At block 304, the process 300 receives an item of content at the content processing device. At block 306, the process 300 automatically performs a search within the item of content for the keyword. At block 308, the process 300 generates an alert upon identification of the keyword within the item of content.

FIG. 4 is a flow chart of an example of an implementation of a process 400 for automated active keyword content searching based upon character patterns, and search result selection. At decision point 402, the process 400 waits for a request from a user via a device, such as the input device 204, to configure a keyword for prospective automated content receipt searches. Upon receipt of an indication or request from the user to configure a keyword for prospective automated content receipt searches, the process 400 receives a keyword and/or character pattern to configure for use in association with prospective automated content receipt searches at block 404. For example, the process 400 may receive the keyword and/or character pattern via the user input device 204 associated with the content processing device 102.

It should be understood that receipt of keyword and/or character pattern at block 404 may include receipt of multi-word phrases and/or multiple character patterns that form a single active keyword for prospective content search purposes. In such a case, a multi-word phrase may be configured and searched for in content that is subsequently received similarly to single keywords and/or single character patterns. Given the similarity in processing of single and multi-word phrases, for purposes of the present description, multi-word phrases will not be further distinguished from single keywords and/or single character patterns. However, it is understood that both single and multi-word patterns may be configured and searched for within content that is subsequently received.

It should also be understood that wildcards and/or exclusionary terms or characters may also be received in association with the keyword and/or character pattern at block 404. At block 406, the process 400 stores the received keyword and/or character pattern and any associated information, such as in the search configuration storage area 216 of the database 214.

It should be noted that processing described above within the process 400 may constitute a completed process to configure an active keyword for use in automated searches of items of content subsequently received at the content processing device. Further, the processing described above may be executed multiple times or multiple active keywords may be received at block 404 to configure multiple active keywords. As such, the processing described below may constitute a separate process without departure from the scope of the present subject matter. As such, the processing described below is described in conjunction with the active keyword configuration processing described above for ease of illustration purposes.

With a keyword for prospective automated searching of items of content subsequently received, the process 400 waits for receipt of content at decision point 408. As described above, receipt of content may include receipt of web content from one of the content server_1 106 through the content server_N 108 in response to a navigation request from the user via the input device 204, receipt of an email, text message, or instant message from the communication device 110. As such, the received content may include text content associated with a web page, text content associated with an email, text content associated with an instant message, text content associated with a text message, text content associated with a streamed data feed, and text content associated with a file read from a memory (e.g., the memory 208) associated with the content processing device 102. Many other possibilities exist for content to be received by the content processing device 102 and all are considered within the scope of the present subject matter.

Upon receipt of content, the process 400 retrieves any configured keyword(s) and/or character pattern(s) at block 410. It is understood that the keyword(s) and/or character pattern(s) may include a plurality of keywords and/or character patterns (e.g., either single word or multi-word phrases) for processing during an automated active keyword content search and that the automated search processing described herein may include automatically searching for matches for each of the plurality of keywords and/or character patterns within the received content. At decision point 412, the process 400 makes a determination as to whether a wildcard character is present within the configured active keyword(s) and/or character pattern(s). When a determination is made that a wildcard character is present within the configured active keyword(s) and/or character pattern(s), the process 400 automatically searches for matches within the received content of the configured active keyword(s) and/or character pattern(s) exclusive of wildcard character positions associated with any wildcard character within the character pattern within the configured active keyword(s) and/or character pattern(s) at block 414.

Upon completion of searching the received content for configured active keyword(s) and/or character pattern(s) exclusive of wildcard positions at block 414 or upon making a determination at decision point 412 that there is no wildcard character present within the configured active keyword(s) and/or character pattern(s), the process 400 makes a determination at decision point 416 as to whether there is an exclusionary term within the configured active keyword(s) and/or character pattern(s). When a determination is made that there is an exclusionary term within the configured active keyword(s) and/or character pattern(s), the process 400 automatically searches the received content for matches of the configured active keyword(s) and/or character pattern(s) that do not include the exclusionary term at block 418. It should be noted that processing at block 418 may also include processing results from the search performed at block 414 to filter and remove any search results generated at that block that include a configured exclusionary term.

Upon completion of searching the received content for configured active keyword(s) and/or character pattern(s) that do not include any configured exclusionary terms at block 418 or upon making a determination at decision point 416 that there is no exclusionary term within the configured active keyword(s) and/or character pattern(s), the process 400 makes a determination as to whether the configured active keyword(s) and/or character pattern(s) are configured to search for close matches within the received content at decision point 420. When a determination is made that the configured active keyword(s) and/or character pattern(s) are configured to search for close matches within the received content, the process 400 automatically searches the received content for close matches relative to the configured active keyword(s) and/or character pattern(s) at block 422. Searching for close matches may include, for example, searching for misspellings of terms, variations in tense of verbs, searching for pronouns for previously identified search terms, and other close match criteria. Many other possibilities exist for close match searches of received content and all are considered within the scope of the present subject matter.

Upon completion of searching the received content for close matches relative to the configured active keyword(s) and/or character pattern(s) at block 422 or upon making a determination at decision point 420 that the configured active keyword(s) and/or character pattern(s) are not configured to search for close matches within the received content, the process 400 makes a determination at decision point 424 as to whether any matches resulted from the processing stages of searching the received content. When a determination is made that there were matches within the received content for any configured active keywords, the process 400 displays the text content and generates an alert at block 426. For purposes of the present subject matter, display of the content may include displaying a dialog box including at least a portion of the content associated with the keyword within the content on a display device, such as the display 202, associated with the content processing device 102. Generation of an alert may include generation of an audible tone via an output device, such as a speaker or buzzer (not shown), or a visual indication via the display 202. At block 428, the process 400 highlights any identified matches based upon the criteria described above for any configured active keyword(s) and/or character pattern(s). Highlighting any identified matches may include highlighting the keyword(s) and/or character pattern(s) within a portion of the content that is displayed.

At block 430, the process 400 displays the search results. For example, the process 400 may open a dialog box with search results listed or may create a pop-up over highlighted terms or phrases within the displayed text. Many other possibilities exist for displaying the search results and all are considered within the scope of the present subject matter. Additionally, when the received content includes text content associated with a web page, the process 400 may display search results including at least one occurrence of the keyword within the text content and contextual text proximate to the occurrence of the keyword within the text content.

At decision point 432, the process 400 makes a determination as to whether a selection event has been received in association with any item of the displayed search results, such as via the input device 204. When a determination is made that a selection event has been received in association with any item of the displayed search results, the process 400 navigates to the selected search item within the displayed text content at block 434. As such, receipt of a selection via the input device 204 associated with one of the displayed search results causes the process 400 to navigate to the selected search result within the displayed text content.

The process 400 returns to decision point 432 to determine whether another selection event has been received in association with any item of the displayed search results. When a determination is made that a selection event has not been received in association with any item of the displayed search results, the process 400 makes a determination at decision point 436 as to whether viewing of the present page of the displayed content is complete. For example, the process 400 may make this determination based upon detected user input received via the input device 204, such as via a “page down” key press or a mouse click associated with a “next page” or other button within a graphical user interface associated with a web browser or other content rendering application. For the purpose of searching for active keywords, the user does not have to navigate to the end of the page for the search process to take place. Even if a matching keyword exists at the bottom of the page when the user opens it, the search hit alerts the user of a match at that point, regardless of whether the user has navigated the bottom of the page into view.

When a determination is made that viewing of the present page of the displayed content is not complete, the process 400 returns to decision point 432 to continue iterating as described above. When a determination is made at decision point 436 that viewing of the present page of the displayed content is complete or upon determining that there was no match resulting from the processing stages of searching the received content at decision point 424, the process 400 makes a determination at decision point 438 as to whether there is another page of content to be processed, such as for multi-page web content. As described above, multi-page content may include lists of items or other content that is either received or rendered sequentially.

When a determination is made at decision point 438 that another page of content is available for processing, the process 400 returns to decision point 408 to receive or begin rendering an additional page of the multi-page content at the content processing device and automatically perform a search within the additional page of the multi-page content for the keyword(s) and/or character pattern(s) and continues to iterate as described above. When a determination is made at decision point 438 that there is not another page of content available for processing, the process 400 returns to decision point 402 to await another request from a user via a device, such as the input device 204, to configure a keyword for prospective automated content receipt searches. However, it is understood that the process 400 may alternatively return to decision point 408 to allow additional processing associated with additional received content without departure from the scope of the present subject matter.

As such, the process 400 provides for active keyword configuration for prospective automated content receipt searches in association with content received at a content processing device. The process 400 also provides for active keyword searching and processing for such a device. The active keyword search may be performed in association with receipt of any content that may be parsed and inspected either upon receipt or upon rendering to identify active keywords, including wildcard and exclusionary searches, and may include close matching of configured active keywords. Many other possibilities exist for processing configured active keywords in association with received content and all are considered within the scope of the present subject matter.

It should further be noted that the processing of FIG. 4 may be partitioned into multiple processes without departure from the scope and content of the present subject matter. For example, a process that allows configuration of one or more active keywords may be executed and the configured active keywords may be stored for use in subsequent automated searches of received content. Another process may be executed upon subsequent receipt of content that processes the received content based upon the configured keyword(s) and may be executed for each receipt of content. The process 400 or other processes may further be modified to provide for removal, activating, and deactivating of active keywords without departure from the scope of the present subject matter. As such, processing of received content based upon configured active keywords may continue for each item of content received until a configured active keyword is deactivated or removed from an active list of keywords. Many other variations on the processes described above are possible and all are considered within the scope of the present subject matter.

As described above in association with FIG. 1 through FIG. 4, the example systems and processes provide automated active keyword content searching. Many other variations and additional activities associated with automated active keyword content searching are possible and all are considered within the scope of the present subject matter.

Those skilled in the art will recognize, upon consideration of the above teachings, that certain of the above examples are based upon use of a programmed processor, such as the CPU 200. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above and below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
configuring, at a content processing device, a keyword for use in automated searches of items of content subsequently received at the content processing device;
receiving an item of content at the content processing device;
automatically performing a search within the item of content for the keyword; and
generating an alert upon identification of the keyword within the item of content.

2. The method of claim 1, where configuring, at the content processing device, the keyword for use in automated searches of items of content subsequently received at the content processing device comprises:
receiving a character pattern via a user input device associated with the content processing device; and
storing the character pattern as the keyword within a memory associated with the content processing device.

3. The method of claim 2, where the character pattern comprises at least one of a multi-word phrase, a wildcard character, and an exclusion term and where automatically performing the search within the item of content for the keyword comprises at least one of:
automatically searching for the multi-word phrase within the item of content;
automatically searching for matches within the item of content for the character pattern exclusive of character positions associated with the at least one wildcard character within the character pattern;
automatically searching for matches within the item of content for the character pattern that do not include the exclusion term; and
automatically searching for close matches within the item of content.

4. The method of claim 2, where the character pattern comprises a plurality of keywords and where automatically performing the search within the item of content for the keyword comprises automatically searching for matches for each of the plurality of keywords within the item of content.

5. The method of claim 1, where the item of content comprises multi-page web content and further comprising receiving an additional page of the multi-page web content at the content processing device and automatically performing a search within the additional page of the multi-page web content for the keyword.

6. The method of claim 1, where receiving the item of content at the content processing device comprises receiving text content selected from a group consisting of text content associated with a web page, text content associated with an email, text content associated with an instant message, text content associated with a text message, text content associated with a streamed data feed, and text content associated with a file read from a memory associated with the content processing device.

7. The method of claim 1, where generating the alert upon identification of the keyword within the item of content comprises:
displaying a dialog box comprising at least a portion of the item of content associated with the keyword within the item of content on a display device associated with the content processing device; and
highlighting the keyword within the at least a portion of the item of content.

8. The method of claim 1, where the item of content comprises text content associated with a web page and where generating the alert upon identification of the keyword within the item of content comprises:
displaying the text content on a display device associated with the content processing device;
displaying search results comprising at least one occurrence of the keyword within the text content and contextual text proximate to the at least one occurrence of the keyword within the text content;
receiving a selection associated with one of the displayed search results via a user input device associated with the content processing device; and
navigating to the selected search result within the displayed text content.

9. A system, comprising:
a content processing device programmed to:
configure a keyword for use in automated searches of items of content subsequently received;
receive an item of content;
automatically perform a search within the item of content for the keyword; and
generate an alert upon identification of the keyword within the item of content.

10. The system of claim 9, further comprising:
a user input device;
a memory; and
where in being programmed to configure the keyword for use in automated searches of items of content subsequently received, the content processing device is programmed to:
receive a character pattern via the user input device;
store the character pattern as the keyword within the memory; and
where the character pattern comprises at least one of a multi-word phrase, a wildcard character, and an exclusion term; and
where in being programmed to automatically perform the search within the item of content for the keyword, the content processing device is programmed to at least one of:
automatically search for the multi-word phrase within the item of content;
automatically search for matches within the item of content for the character pattern exclusive of character positions associated with the at least one wildcard character within the character pattern;
automatically search for matches within the item of content for the character pattern that do not include the exclusion term; and
automatically search for close matches within the item of content.

11. The system of claim 9, further comprising:
a memory; and
where in being programmed to receive the item of content, the content processing device is programmed to receive text content selected from a group consisting of text content associated with a web page, text content associated with an email, text content associated with an instant message, text content associated with a text message, text content associated with a streamed data feed, and text content associated with a file read from the memory.

12. The system of claim 9, further comprising:
a display device;
a user input device; and
where the item of content comprises text content associated with a web page; and
where in being programmed to generate the alert upon identification of the keyword within the item of content, the content processing device is programmed to:
display the text content on the display device;
display search results comprising at least one occurrence of the keyword within the text content and contextual text proximate to the at least one occurrence of the keyword within the text content;
receive a selection associated with one of the displayed search results via the user input device; and
navigate to the selected search result within the displayed text content.

13. A computer program product comprising a computer readable storage medium including a computer readable program code, wherein the computer readable program code when executed on a computer causes the computer to:
configure a keyword for use in automated searches of items of content subsequently received;
receive an item of content;
automatically perform a search within the item of content for the keyword; and
generate an alert upon identification of the keyword within the item of content.

14. The computer program product of claim 13, where in causing the computer to configure the keyword for use in automated searches of items of content subsequently received, the computer readable program when executed on the computer causes the computer to:
receive a character pattern via a user input device; and
store the character pattern as the keyword within a memory.

15. The computer program product of claim 14, where the character pattern comprises at least one of a multi-word phrase, a wildcard character and an exclusion term and where in causing the computer to automatically perform the search within the item of content for the keyword, the computer readable program when executed on the computer causes the computer to at least one of:
automatically search for the multi-word phrase within the item of content;
automatically search for matches within the item of content for the character pattern exclusive of character positions associated with the at least one wildcard character within the character pattern;
automatically search for matches within the item of content for the character pattern that do not include the exclusion term; and
automatically search for close matches within the item of content.

16. The computer program product of claim 14, where the character pattern comprises a plurality of keywords and where in causing the computer to automatically perform the search within the item of content for the keyword, the computer readable program when executed on the computer causes the computer to automatically search for matches for each of the plurality of keywords within the item of content.

17. The computer program product of claim 13, where the item of content comprises multi-page web content and where the computer readable program code when executed on the computer further causes the computer to receive an additional page of the multi-page web content and automatically perform a search within the additional page of the multi-page web content for the keyword.

18. The computer program product of claim 13, where in causing the computer to receive the item of content, the computer readable program when executed on the computer causes the computer to receive text content selected from a group consisting of text content associated with a web page, text content associated with an email, text content associated with an instant message, text content associated with a text message, text content associated with a streamed data feed, and text content associated with a file read from a memory.

19. The computer program product of claim 13, where in causing the computer to generate the alert upon identification of the keyword within the item of content, the computer readable program when executed on the computer causes the computer to:
display a dialog box comprising at least a portion of the item of content associated with the keyword within the item of content on a display device; and
highlight the keyword within the at least a portion of the item of content.

20. The computer program product of claim 13, where the item of content comprises text content associated with a web page and where in causing the computer to generate the alert upon identification of the keyword within the item of content, the computer readable program when executed on the computer causes the computer to:
display the text content on a display device;
display search results comprising at least one occurrence of the keyword within the text content and contextual text proximate to the at least one occurrence of the keyword within the text content;
receive a selection associated with one of the displayed search results via a user input device; and
navigate to the selected search result within the displayed text content.
